(19) United States
(12) Patent Application Publication
(10) Pub. No.: US 2026/0331758 A1
(43) Pub. Date: Oct. 22, 2026

(54) RADOME CONFIGURATION FOR UTILITY METER ANTENNA

(71) Applicant: Badger Meter, Inc., Milwaukee, WI (US)

(72) Inventors: Patrick C. Winkler, East Troy, WI (US); Daniel W. Fellers, Mequon, WI (US); Joseph J. Kopnick, Milwaukee, WI (US)

(21) Appl. No.: 19/181,959

(22) Filed: Apr. 17, 2025

(51) Int. Cl. H01Q 1/42; H01Q 1/22

(52) U.S. Cl. CPC H01Q 1/42; H01Q 1/2233

(57) ABSTRACT

A transmitter assembly configured for transmitting utility meter data to a remote utility meter data collection unit from a subsurface utility meter enclosed within a subsurface enclosure having a lid is described. The assembly includes a lower transmitter assembly extending from the lid into the subsurface enclosure and passing at least partially through a lid opening, the lower transmitter assembly configured to include a radio frequency communication circuit and a radome configured to include a radome housing configured to receive a portion of the lower transmitter assembly passing at least partially through the lid opening. The radome includes an antenna board including one or more passthrough apertures, a radome base including one or more lower support posts extending from a floor of the radome base toward one of the passthrough apertures of the antenna board, and a radome lid including one or more upper support posts extending from a roof of the radome lid toward one of the passthrough apertures of the antenna board. The location of each of the lower support posts on the radome base aligns with a corresponding upper support posts on the radome lid and each of the each of the lower support posts and corresponding upper support posts define a support post clearance therebetween.

### FIELD OF THE INVENTION

This application relates to a radome for a utility meter configured to facilitate communication in a configuration that improves radome life and robustness. More specifically, the present application is directed to a radome for a utility meter including a support structure to facilitate the manufacturing and operation of the radome using the support structure(s) described herein.

### BACKGROUND

Utility meters, particularly water meters, are located in subsurface ground enclosures in areas near residences or other dwellings. Such enclosures are referred to as “pits.” In these systems, a transmitter or transceiver and an associated antenna are enclosed in one or more sealed enclosures which are located in or on a larger pit for the water meter. In exemplary embodiments of these subsurface ground enclosures, the antenna is disposed at least in part in an upper portion and the electronics are installed at least in part in a lower portion with a hermetic seal between the two portions. The utility meter, in combination with the radio transmitter and antenna arrangement are employed for the purpose of transmitting readings of such meter for utility consumption tracking.

A primary issue concerning all meter systems, whether used in pit installations or elsewhere, is their resistance to weather and/or other environmental effects, specifically, for example, to submersion in the event that the pit fills with water. Therefore, the invention provides a device that is very resistant to moisture conditions in its operating environment. Typically, the device and/or the various components thereof, are powered by one or more batteries, which must also be contained in a sealed enclosure.

In addition to the environment within the pit, the antenna for the utility meter, to maximize transmission strength, is placed outside of the pit, typically within or affixed to a pit cover at ground level. As such, the antenna is operated in an environment subject to unpredictable surroundings, weather conditions, and external forces such as foot traffic and/or lawn care equipment. Surrounding materials may include, for example, metal, plastic, concrete, organics, etc.

Accordingly, antenna for such utility meter configurations are typically provided within a radome. A radome is a structural, weatherproof enclosure that protects an enclosed antenna. The radome is typically constructed of material transparent to radio waves. Radomes protect the antenna from weather and the enclosed antenna electronic equipment from other external forces. In the present example, the radome is provided in a primarily planar configuration. Radome configuration is typically provided to maximize protection of the enclosed antenna while simultaneously maximizing antenna performance. Antenna performance is provided by increasing transmission strength while minimizing power requirements to achieve that transmission strength.

What is needed is a radome configuration for use with a subsurface utility meter. What is further needed is such a radome configuration that provides an internal radome support structure configured to improve radome construction and transmissivity.

### SUMMARY OF THE INVENTION

This invention is directed to a transmitter assembly for transmitting utility meter data to a remote utility meter data collection unit from a subsurface utility meter enclosed within a subsurface enclosure having a lid that includes a radome positioned adjacent to and above the pit lid. The radome includes an internal radome support structure configured to improve radome construction and transmissivity.

In one exemplary embodiment, a transmitter assembly configured for transmitting utility meter data to a remote utility meter data collection unit from a subsurface utility meter enclosed within a subsurface enclosure having a lid is shown. The assembly includes a lower transmitter assembly extending from the lid into the subsurface enclosure and passing at least partially through a lid opening, the lower transmitter assembly configured to include a radio frequency communication circuit, and a radome configured to include a radome housing configured to receive a portion of the lower transmitter assembly passing at least partially through the lid opening. The radome includes an antenna board including one or more passthrough apertures, a radome base including one or more lower support posts extending from a floor of the radome base toward one of the passthrough apertures of the antenna board, and a radome lid including one or more upper support posts extending from a roof of the radome lid toward one of the passthrough apertures of the antenna board. The location of each of the lower support posts on the radome base aligns with a corresponding upper support posts on the radome lid and each of the each of the lower support posts and corresponding upper support posts define a support post clearance therebetween.

In another more detailed aspect, the assembly includes at least one of a lower support post, a corresponding upper support post and a support post clearance passes through a passthrough aperture of the antenna board. In another detailed aspect, the support post clearance is a 0.001 inch to 0.019 inch spacing between a lower support post and an upper support post.

In another detailed aspect, the radome base and the radome lid are ultrasonically welded to each other. The support post clearance may be provided such that the support post clearance is maintained following the ultrasonic welding of the radome base and radome lid for at least a portion of the support posts.

In another more detailed aspect, the support post clearance is configured to close when external force is applied to the radome.

In another embodiment, the invention provides a transmitter assembly configured for transmitting utility meter data to a remote utility meter data collection unit from a subsurface utility meter enclosed within a subsurface enclosure having a lid is described. The transmitter assembly includes a radome housing configured to receive a portion of the lower transmitter assembly passing at least partially through the lid opening. The radome housing includes an antenna board including one or more passthrough apertures, a radome base including one or more lower support posts extending from a floor of the radome base toward one of the passthrough apertures of the antenna board, and a radome lid including one or more upper support posts extending from a roof of the radome lid toward one of the passthrough apertures of the antenna board. The radome is configured such that the location of each of the lower support posts on the radome base aligns with a corresponding upper support posts on the radome lid and each of the each of the lower support posts and corresponding upper support posts define a support post clearance therebetween.

In yet another embodiment, the invention provides a transmitter assembly configured for transmitting utility meter data to a remote utility meter data collection unit from a subsurface utility meter enclosed within a subsurface enclosure having a lid is described. The transmitter assembly includes a radome housing configured to receive a portion of the lower transmitter assembly passing at least partially through the lid opening. The radome housing includes an antenna board including one or more passthrough apertures, a radome base including one or more lower support ridges extending from a floor of the radome base toward one of the passthrough apertures of the antenna board, and a radome lid including one or more upper support ridges extending from a roof of the radome lid toward one of the passthrough apertures of the antenna board. The radome is configured such that the location of each of the lower support ridges on the radome base aligns with a corresponding upper support ridges on the radome lid and each of the each of the lower support ridges and corresponding upper support ridges define a support post clearance therebetween.

Other aspects of the invention, besides those discussed above, will be apparent to those of ordinary skill in the art from the description of the preferred embodiments which follows. In the description, reference is made to the accompanying drawings, which form a part hereof, and which illustrate examples of the invention.

### BRIEF DESCRIPTION OF THE DRAWINGS

FIG. 1 is a side view in elevation of a subsurface utility meter in a subsurface enclosure, according to an exemplary embodiment;

FIG. 2 is a side view of a transmitter assembly having a radome connected to a lower transmitter assembly and a close up view of the connection, respectively, according to an exemplary embodiment;

FIG. 3 is the transmitter assembly of FIG. 2 including a lower transmitter assembly and a cross section view of a radome in a perspective view, according to an exemplary embodiment;

FIGS. 4A-C are a perspective view of a radome base, a perspective view of a radome lid, and a close-up cross-section view of the radome base and radome lid in an assembled configuration, respectively, according to an exemplary embodiment;

FIG. 5A is top down of the antenna board of FIG. 3, according to an exemplary embodiment; and

FIG. 5B is top down of the antenna board of FIG. 3, according to an alternative embodiment.

### DETAILED DESCRIPTION OF THE INVENTION

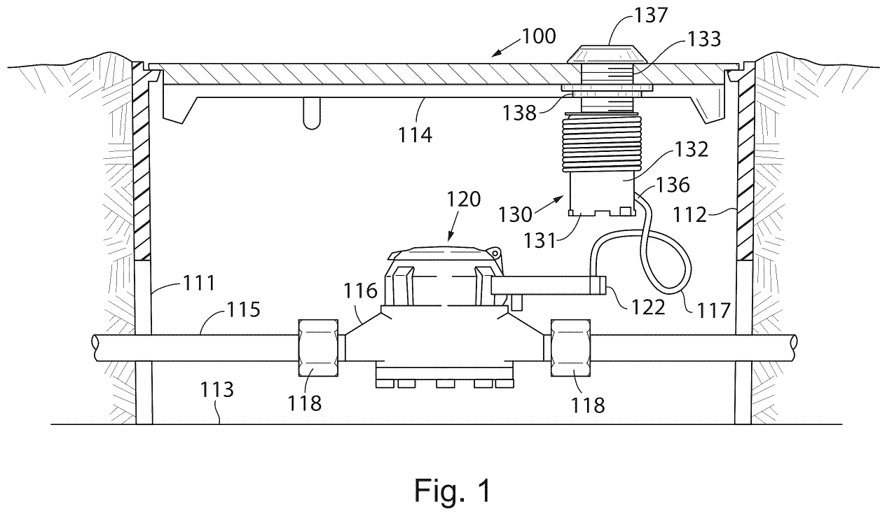

Referring now to FIG. 1, a subsurface enclosure 100, referred to herein as a subsurface utility meter enclosure or “pit” is shown in a typical configuration, according to an exemplary embodiment known in the art. The enclosure 100 is positioned at and below the surface of the ground and includes opposing, generally upright side walls 111, 112, an open or closed bottom 113 and a lid 114 at approximately ground level for closing the enclosure 100 from the top. Enclosure 100 is preferably made of a non-metallic polymer material, but other non-metallic materials such as concrete, polyethylene, and various other composite materials can be used. The enclosure can also be metallic for the different configurations but may not be optimal due to the effect of a large metal object on radio transmissions from equipment installed in the pit.

A utility conduit 115 runs through the enclosure 100 below ground level.

A meter housing 116 containing a utility metering element (not shown) is connected in the utility conduit 115 inside the pit enclosure 100 using ends 118.

The flow of the utility through the conduit 115 in response to demand are sensed by a meter measurement device 120. Although a particular example of a meter measurement is shown, it should be understood by one of ordinary skill the art that the present meter may be used with any type of meter including, but not limited to, mechanical meters, electronic meter, magnetic meters, ultrasonic meters, etc. The meter measurement device 120 provides either one or both of a visual display for displaying water consumption data and a transmitter for transmitting an electrical signal corresponding to utility consumption data. The signal, in the embodiment shown, is transmitted via an electrical cable 117 to a transmitter assembly 130 enclosed within transmitter housing 131. The electrical signal may be transmitted using a wired connection as shown or a wireless signal. Transmitter housing 131 provides a double wall of protection for the electronics housed inside the transmitter assembly 130. The transmitter assembly 130 will transmit radio frequency signals to a mobile or fixed data collector (not shown) of a type known in the art and will in some cases receive signals from the data collector.

Transmitter assembly 130 is configured to include an elongated transmitter body 132 attached through the pit lid 114 to a radome 137. The transmitter body 132 provides a housing with a threaded upper portion 133 that is received with a mating threaded aperture (not shown) in the radome 137 in an exemplary embodiment. A flanged, threaded retainer 138 may be installed on the threaded upper portion 133 before inserting the transmitter body 132 through a hole in the pit lid 114. The retainer 138 can be adjusted to control the height of the transmitter body 132 extending into and/or through the pit lid 114 and to clamp the assembly 130 to the pit lid 114. This exemplary configuration is suitable for metal pit lids, as an antenna within the radome 137, connected to the transmitter body 132, will reside above the pit lid 114.

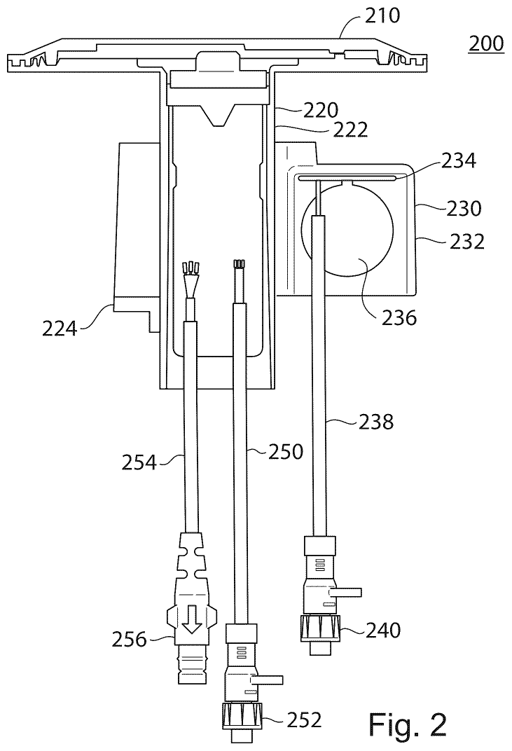

The electrical cable 117 is connected on one end to the meter register 120 and is unwound from a lower tubular portion of transmitter body 132 at connection point 136. The electrical cable 117 is connected to the meter measurement device at a connection point 122. Although a particular embodiment is shown, numerous alternative configurations are contemplated, such as the alternative embodiment shown and described below with reference to FIG. 2.

Referring now to FIG. 2, a transmitter assembly 200 having a radome 210 connected to a lower transmitter assembly 220 is shown, according to an exemplary embodiment. In the embodiment shown, transmitter assembly 200 is configured for cellular communication of measured metering data. Transmitter assembly 200 is a top loading cellular endpoint designed for superior performance in metal pit lid installations. Advantageously, transmitter assembly 200 as described herein is configured to avoid utilization of a “Coverage Enhancement” (CE) mode, previously needed when such assemblies were installed in metal pit lids, which drastically shortens battery life. The present invention also avoids the difficulties of the alternative previous solution, where a meter installer swapped out a metal pit lid being used for a composite (plastic) lid which cost both dollars and time for utility customers and providers.

Lower transmitter assembly 220 is configured to house a cellular printed circuit board assembly (PCBA) 222. Cellular PCBA 222 is configured for connecting and controlling the various electronic components to implement cellular connections and transmission. Cellular PCBA 222 may be configured to be a variant of standard cellular boards with similar components in a different layout to implement the functionality described herein. For example, PCBA 222 may be configured such that a portion of the PCBA 222 will pass through a center bottom hole in the radome 210 to allow for a wired solder joint to be made with the antenna enclosed therein, although various alternative configurations may also be implemented.

Radome 210, as shown and further described herein, is configured to be attached to the lower transmitter assembly 220 through an opening in a pit lid 114. Radome 210 and lower transmitter assembly 220 may alternatively be provided in a variety of configurations for cellular transmissions while providing the advantages described herein.

Lower transmitter assembly 220 is configured for connection with an external battery component 230. External battery assembly 230 may be configured to be integrated into a threaded lock nut assembly that secures the transmitter assembly 200 in place via the underside of the pit lid 114. Battery component 230 includes a battery housing 232 configured to include a battery PCBA 234 including the battery terminals (not shown) and a power output wire 238 and to secure a battery 236. Following assembly, battery housing 232 may be filled with epoxy for moisture protection. Battery housing 232 may further be configured to include battery support posts that will position and hold the battery 236 as the epoxy cures relative to battery PCBA 234.

Lower transmitter assembly 220 may be configured to include a threaded portion (not shown) along a portion of its elongated direction. The threaded portion is configured to receive a locking collar 224 that threads up the elongated housing of the lower transmitter assembly 220 and snugs up against the underside of a pit lid 114. One of ordinary skill in the art should appreciate that the locking portion may be implemented in a variety of different ways.

Power output wire 238 may be a water-resistant wire/connector assembly including internal polyethylene wire insulation and jacketed with an additional polyvinyl chloride (PVC) external jacket. The polyethylene layers may be configured for moisture resistance and the external PVC jacket may be provided to facilitate bonding to a connector 240. The connector may be “twist tight” connector in one exemplary embodiment.

Transmitter assembly 200 may be configured to utilize a primary and secondary battery. The primary battery, shown here as battery 236 provides the overall capacity needed to meet the battery life requirements of the transmitter assembly 200. The secondary battery (not shown) may be physically and/or electrically connected with PCBA 222 and configured to provide high current pulse loads required for the actual cellular transmissions.

Accordingly, battery 236 may be a D-cell lithium thionyl chloride battery to meet the life requirements for transmitter assembly 200 while maintaining a desired reporting cellular cadence reporting meter readings from a connected utility meter with desired frequency.

Lower transmitter assembly 220 is configured to be secured to battery assembly 230 by the locking collar 224 that threads up the elongated housing of the lower transmitter assembly 220. In the current embodiment shown herein, lower transmitter assembly 220, operating as an endpoint for an associated utility meter is installed such that at least a portion of the lower transmitter assembly 220 is positioned below the bottom of the pit lid 114. Such an installation allows utilization of a D-cell battery 236 that is otherwise too large to fit through the industry standard hole size in a pit lid 114.

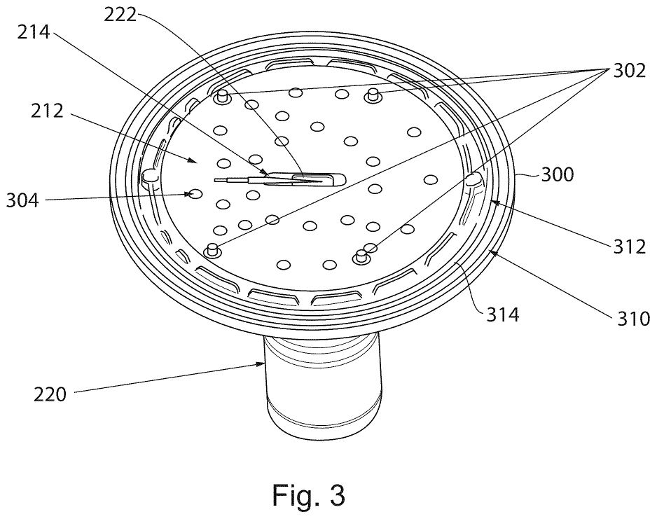

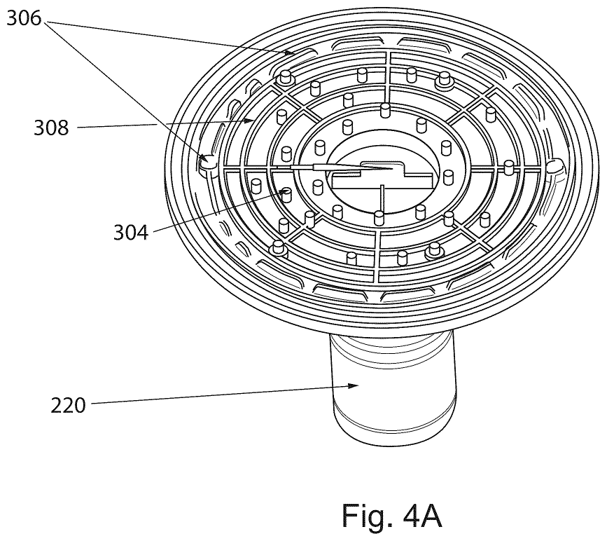

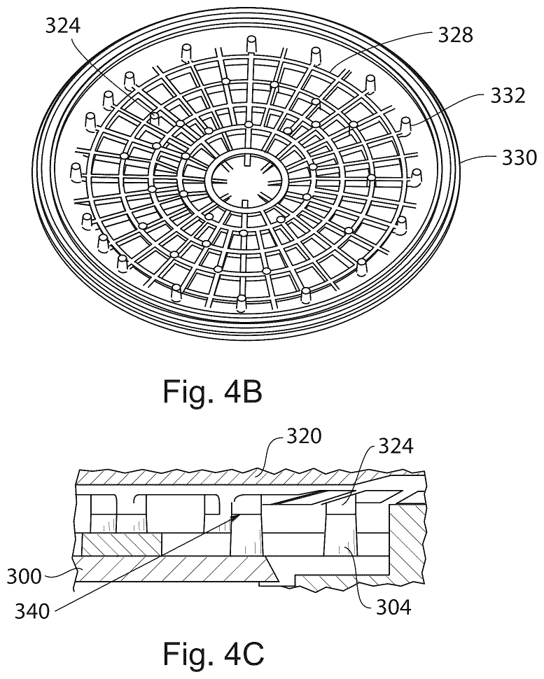

The transmitter assembly 200 configuration allows use of an improved antenna, further described below with reference to FIGS. 3 and 4, that is also too large to fit through the industry standard hole size in a pit lid 114. This is in combination with the D-cell battery 236 size requirement. In this embodiment the main D-cell battery 236 is connected to PCBA 222 externally via a wired connection using power output wire 238 and connector 240, while the secondary battery is positioned on the cellular PCBA 222. The power configuration described herein provides the advantage of maintaining power to the cellular PCBA 222 during main power disconnect from battery 236. The secondary battery also keeps the high current spikes required by the secondary battery to a short distance to the sourced modem. The connection of the primary battery to the secondary battery and electronics is done using a power wire 250 and connector 252 and a data wire 254 and connector 256. The connection between the primary and secondary battery and electronics is maintained during storage and shipment. The devices are disconnected for the installation through the lid and then reconnected.

Referring now to FIG. 3, the transmitter assembly 200, including lower transmitter assembly 220 and a cross-section cutaway view of radome 210, is shown in a perspective view, according to an exemplary embodiment. Cellular PCBA 222 is shown extending from the lower transmitter assembly 220 into radome 210 to be connected to thereto at a coaxial connection 214.

Referring now also to FIG. 4A-C, radome 210 is configured as a two-part clamshell design including a radome base 300 and radome lid 320. The shape and configuration of radome base 300 and radome lid 320 is configured based on the application and antenna to be used therein. The shape of radome base 300 is configured to mate with a pit lid 114 such that entirety of an underside of radome base 300 is supported by a top surface of a pit lid 114. The shape of radome lid 320 is configured to reduce the profile of the radome 210 while allowing sufficient spacing from radome base 300 to facilitate inclusion of antenna board 212 and support structure to position and protect the antenna board from external forces.

Radome 210 is configured to include internal structural ribbing and support posts for reduced bending under load. Radome base 300 is configured to include the base support structure to position and protect the antenna board 212 from external forces.

To position the antenna board 212, radome base 300 includes at least two positioning and securing posts 302. The embodiment shown in FIGS. 3 and 4A includes four (4) positioning and securing posts 302 configured to extend from a floor of radome base 300 through antenna board 212. Positioning and securing posts 302 may include a wide base portion and a narrow passthrough portion where the antenna board 212 is configured to seat against the wide base portion and the narrow passthrough portion is configured to extend through the antenna board 212 when it is so seated. The narrow passthrough portion may then be formed by heat staking by being deformed through cold ﬂow or melting of the narrow portion of the securing post 302 to form a head that mechanically locks the antenna board 212 in a fixed position on the radome base 300. Advantageously, support posts 302 raise and hold the antenna board 212 up from the floor of the radome base 300 to secure and protect the antenna board 212 including the antenna and ground plane for cellular communications.

Radome base 300 may further be configured to include one or more keying features 306 to secure and position the antenna board 212 and position the radome lid 320 to align the support features described herein. As shown in FIG. 4A, the keying features 306 may include a circumferential ring configured to align with the outermost circumference of an antenna board 212 and/or one or more positioning features positioned at points to further secure and support the antenna board 212. Radome base 300 may further include internal support ribbing 308 to provide structural strength in the radome base 300. Radome lid 320 is also configured to internal support ribbing 328 to provide structural strength in the radome lid 320.

Radome base 300 and radome lid 320 will be ultrasonically welded for a permanent seal. Accordingly, both of Radome base 300 and radome lid 320 are configured to include a base ultrasonic weld channel 310 and a lid ultrasonic weld channel 330, respectively. Ultrasonic welding is an industrial process whereby high-frequency ultrasonic acoustic vibrations are locally applied to work pieces being held together under pressure to create a solid-state weld. It is commonly used for plastics and metals. In ultrasonic welding, there are no connective bolts, nails, soldering materials, or adhesives necessary to bind the materials together. When used to join metals, the temperature stays well below the melting point of the involved materials beyond the location of the joint, preventing any unwanted properties which may arise from high temperature exposure to the metal.

Radome base 300 is further configured to include a channel 314 configured to encompass an internal O-ring 312 as a backup to the ultrasonic weld. Base lid 320 is configured to secure the O-ring 312 within the channel 314 when the radome 210 is assembled. Radome 210 may yet further include desiccant to enclosed therein for moisture management.

Radome base 300 further includes one or more lower support posts 304 configured to also extend from the floor of the radome base 310. Radome lid 320 includes one or more upper support posts 324 configured to extend from the roof of the radome lid 320. The number and positioning of low supports 304 and upper support posts 324 are aligned such that each set of corresponding support posts will form a support post clearance 340 when the radome 210 is assembled. According to an exemplary embodiment, the support post clearance 340, i.e., the distance between a lower support post 304 and its corresponding upper support post 324 is a nominal gap, such as a nominal value of 0.006 inches. With a tolerance stack up, the clearance ranges from 0.001″ to 0.019″.

Advantageously, the support post clearance 340, provided some distance from an outer weld circumference will not interfere with the joining of the radome lid 320 and the radome base 310. The support post clearance 340 further allows for thermal expansion within the radome 300, allows for shifting load dependent on external pressure to the radome 300, etc.

The upper and lower support posts 304, 324 gap defines a minimal clearance between them to define a support post clearance 340 in the neutral position but upper and lower support posts 304, 324 are also configured to interface quickly under load to distribute load and provide structural protection for the antenna board 212. Support post clearance 340 facilitates the ultrasonic welding of the radome 210 by preventing an effect and/or welding of the antenna board 212 by the ultrasonic welding process.

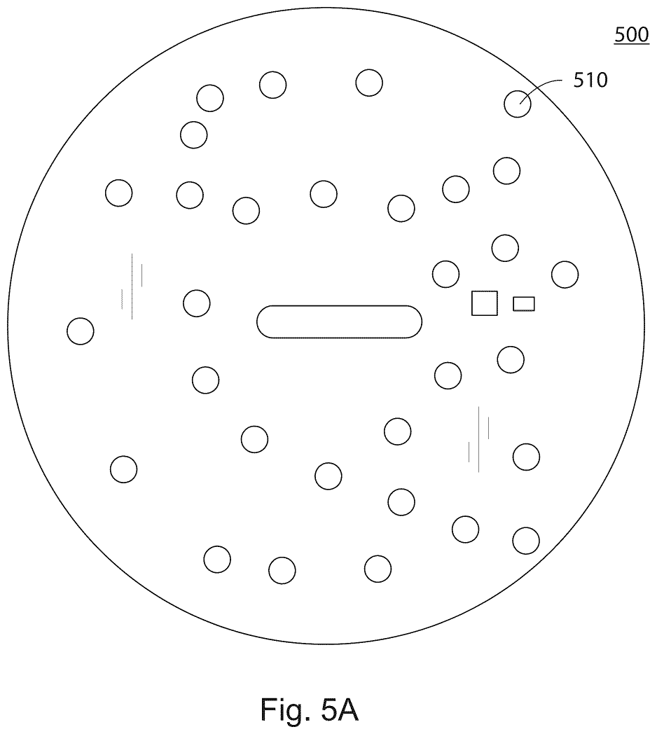

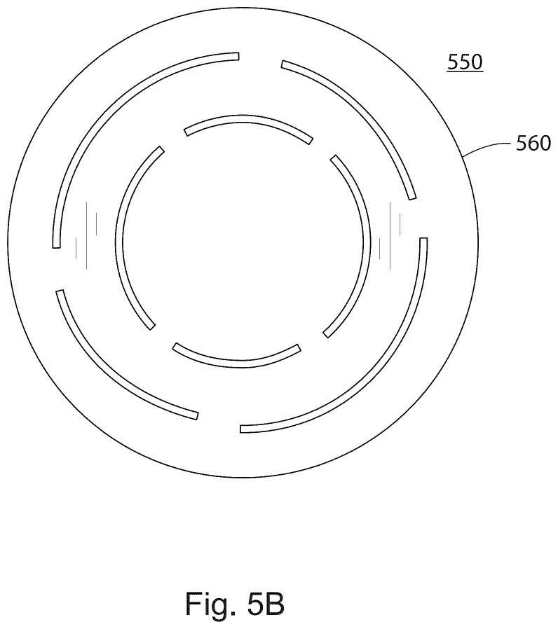

Referring now to FIG. 5A, antenna board 500 is shown in a top-down view, configured to include one or more support passthrough apertures 510, according to an exemplary embodiment. The antenna board 500 passthrough apertures 510 allow the support posts 304 and 324 on the radome base 300 and radome lid 320 to transfer top load stress through the antenna board 212 without directly affecting the antenna board 212. Advantageously, passthrough apertures 510 allow a more advantageous and less interfering positioning of support posts to minimize the impact of external forces on the radome 210.

Referring now to FIG. 5A, antenna board 550 is shown in a top-down view, configured to include one or more support passthrough apertures 560, according to an alternative embodiment. The antenna board 550 passthrough apertures 560 are configured to allow an alternative support structure, specifically one or more support ribs on the radome base 300 and radome lid 320 to transfer top load stress through the antenna board 212 without directly affecting the antenna board 212. Advantageously, passthrough apertures 560 allow a more advantageous and less interfering positioning of support posts to minimize the impact of external forces on the radome 210 with an alternative structure.

This has been a description of the preferred embodiments, but it will be apparent to those of ordinary skill in the art that variations may be made in the details of these specific embodiments without departing from the scope and spirit of the present invention, and that such variations are intended to be encompassed by the following claims.

We claim:

1. A transmitter assembly configured for transmitting utility meter data to a remote utility meter data collection unit from a subsurface utility meter enclosed within a subsurface enclosure having a lid, comprising:
a lower transmitter assembly extending from the lid into the subsurface enclosure and passing at least partially through a lid opening, the lower transmitter assembly configured to include a radio frequency communication circuit; and
a radome configured to include a radome housing configured to receive a portion of the lower transmitter assembly passing at least partially through the lid opening, the radome including
an antenna board including one or more passthrough apertures,
a radome base including one or more lower support posts extending from a floor of the radome base toward one of the passthrough apertures of the antenna board, and
a radome lid including one or more upper support posts extending from a roof of the radome lid toward one of the passthrough apertures of the antenna board,
wherein the location of each of the lower support posts on the radome base aligns with a corresponding upper support posts on the radome lid,
further wherein each of the each of the lower support posts and corresponding upper support posts define a support post clearance therebetween.

2. The transmitter assembly of claim 1, wherein at least one of a lower support post, a corresponding upper support post and a support post clearance passes through a passthrough aperture of the antenna board.

3. The transmitter assembly of claim 1, wherein the support post clearance is a 0.001 inch to 0.019 inch spacing between a lower support post and an upper support post.

4. The transmitter assembly of claim 1, wherein the radome base and the radome lid are ultrasonically welded.

5. The transmitter assembly of claim 4, wherein the support post clearance is maintained following the ultrasonic welding of the radome base and radome lid for at least a portion of the support posts.

6. The transmitter assembly of claim 1, wherein the support post clearance is configured to close when external force is applied to the radome.

7. A transmitter assembly configured for transmitting utility meter data to a remote utility meter data collection unit from a subsurface utility meter enclosed within a subsurface enclosure having a lid, comprising:
a radome housing configured to receive a portion of the lower transmitter assembly passing at least partially through the lid opening, the radome including
an antenna board including one or more passthrough apertures,
a radome base including one or more lower support posts extending from a floor of the radome base toward one of the passthrough apertures of the antenna board, and
a radome lid including one or more upper support posts extending from a roof of the radome lid toward one of the passthrough apertures of the antenna board,
wherein the location of each of the lower support posts on the radome base aligns with a corresponding upper support posts on the radome lid,
further wherein each of the each of the lower support posts and corresponding upper support posts define a support post clearance therebetween.

8. The transmitter assembly of claim 7, wherein at least one of a lower support post, a corresponding upper support post and a support post clearance passes through a passthrough aperture of the antenna board.

9. The transmitter assembly of claim 7, wherein the support post clearance is a 0.001 inch to 0.019 inch spacing between a lower support post and an upper support post.

10. The transmitter assembly of claim 7, wherein the radome base and the radome lid are ultrasonically welded.

11. The transmitter assembly of claim 10, wherein the support post clearance is maintained following the ultrasonic welding of the radome base and radome lid for at least a portion of the support posts.

12. The transmitter assembly of claim 7, wherein the support post clearance is configured to close when external force is applied to the radome.

13. A transmitter assembly configured for transmitting utility meter data to a remote utility meter data collection unit from a subsurface utility meter enclosed within a subsurface enclosure having a lid, comprising:
a lower transmitter assembly extending from the lid into the subsurface enclosure and passing at least partially through a lid opening, the lower transmitter assembly configured to include a radio frequency communication circuit; and
a radome configured to include a radome housing configured to receive a portion of the lower transmitter assembly passing at least partially through the lid opening, the radome including
an antenna board including one or more passthrough apertures,
a radome base including one or more lower support structures extending from a floor of the radome base toward one of the passthrough apertures of the antenna board, and
a radome lid including one or more upper support structures extending from a roof of the radome lid toward one of the passthrough apertures of the antenna board,
wherein the location of each of the lower support structures on the radome base aligns with a corresponding upper support structures on the radome lid,
further wherein each of the each of the lower support structures and corresponding upper support structures define a support structure clearance therebetween.

14. The transmitter assembly of claim 13, wherein at least one of a lower support structure, a corresponding upper support structure and a support structure clearance passes through a passthrough aperture of the antenna board.

15. The transmitter assembly of claim 13, wherein the support structure clearance is a 0.001 inch to 0.019 inch spacing between a lower support structure and an upper support structure.

16. The transmitter assembly of claim 13, wherein the radome base and the radome lid are ultrasonically welded.

17. The transmitter assembly of claim 16, wherein the support structure clearance is maintained following the ultrasonic welding of the radome base and radome lid for at least a portion of the support structures.

18. The transmitter assembly of claim 13, wherein the support structure clearance is configured to close when external force is applied to the radome.

19. The transmitter assembly of claim 13, wherein support structure is a structural rib extending from a base into a chamber formed between the radome base and the radome lid.
